(19) United States
(12) Patent Application Publication
(10) Pub. No.: US 2001/0031584 A1
(43) Pub. Date: Oct. 18, 2001

(54) Hybrid plug housing and process for its production

(75) Inventors: Stefan Claus, Mombris (DE); Peter Potzas, Buseck (DE)

Correspondence Address: Klaus P. Stoffel, Esq., Cohen, Pontani, Lieberman & Pavane, Suite 1210, 551 Fifth Avenue, New York, NY, 10176, US

(73) Assignee: W.C. Heraeus GmbH & Co.KG

(21) Appl. No.: 09/824,153

(22) Filed: Apr. 2, 2001

(30) Foreign Application Priority Data
Mar. 31, 2000 (DE) 100 15 993.1

(51) Int. Cl. H01R 13/502

(52) U.S. Cl. 439/695

(57) ABSTRACT

A hybrid plug housing with a base body of plastic, with a conductor array installed permanently therein, where the contacts of the conductor array have a connecting area and a plug-in area. The plug contacts are surrounded laterally by a plug shell of the housing. The plug shell has an opening to accept a mating plug component on the end facing the plug-in direction. A process for the production of the hybrid plug housing makes it possible for the positions of the individual components to be adjusted precisely with respect to each other. The base body and the plug shell are not assembled until after plastic has been injected around the conductor array, which is held together by webs, and until after the plastic has cooled and the webs have been removed.

### BACKGROUND OF THE INVENTION

The invention pertains to a process for the production of a hybrid plug housing with a conductor array comprising at least two contacts, where the contacts have a connecting area at one end and a plug-in area at the other end, by injection or casting a plastic around the conductor array to form a base body such that the connecting areas and the plug-in areas project out from the base body and remain free of plastic, and where the plug-in areas of the, contacts are enclosed laterally by a plug shell, which is a certain distance away from the contacts and which can be attached to the base body in a precisely positioned manner.

Many different types of plug housings are known, and they are used for many different purposes. They are used, for example, for specially designed plugs for electrical or electronic systems. The plug shell serves to protect the contacts in the plug-in area against mechanical damage and to help position the mating plug. For the production of a plug, the contacts are first inserted in a slot in a mold and held in place there. Then the plastic is cast or injected around them. It is necessary for the contacts to be inserted into relatively large openings, and as a result of the shrinkage of the plastic used for injection, the contacts in plugs of this type suffer from a relatively high degree of imprecision in their positioning. Lack of precision on this scale is not a problem for many applications, such as plugs for connecting to standard mains current. For special applications, however, in which very small contact resistances are required, very high positional accuracy is demanded. In applications such as these, inaccurately positioned contacts wear quickly, and the electronic circuitry develops problems.

It is known in principle from, for example, DE 2,831,438 C2 and EP 444,223 A1, that plastic can be injected around several interconnected contacts, and that the connections between them can be cut after the injection process or after the insertion of the contacts into the housing. In the case of plug housings in which the plug connecting area, i.e., the contacts in the plug-in area, are surrounded laterally by a plug shell, however, these processes cannot be used in mass production, because it is impossible, for example, for automatic grippers to install the contacts.

EP 0,924,811 A1 describes a conductor frame with a base element and several contact pins, which branch off from the base element at a right angle. The term “base element” means here a web extending between the contact pins in the connecting area, not in the plug-in area. After the plastic has been injected around the conductor frame and the plug has been formed, the base element is separated from the contact pins.

DE 3,501,391 C2 discloses a housing for an electric component, where a carrier, which forms a single unit with the housing, is provided for the plug pins. The carrier is surrounded by a separate guide and shield frame. The carrier and the guide/shield frame are connected to each other by latching devices. The plug pins are embedded in the plastic of the carrier without the help of webs to fix their position, so that, after the plastic has cooled and cured, the plug pins are no longer positioned precisely with respect to each other.

### SUMMARY OF THE INVENTION

The object of the invention is improve the known state of the art and to provide a process for the production of hybrid plug housings in which the contacts in the plug-in area can be precisely positioned even under automated production conditions.

The task is accomplished according to the invention in that at least two contacts are designed to be connected to each other in their plug-in area by at least one web. The base body is injected or cast around the conductor array, where the web, at least one of which is present, is located outside the base body. After the base body has cooled to room temperature, the web, of which there is at least one, in the plug-in area of the contacts is removed. Finally, the plug shell is attached to the base body. The conductor array consists of several contacts, which have plug-in areas at one end, which are surrounded by the plug shell, and connecting areas at the other end, to which an electric cable is connected.

As a result of the features according to the invention, it is possible for the contacts to be injection-molded or cast in such a way that their plug-in areas are precisely positioned. The two-part design of the housing with a base body and a plug shell ensures that the plug contacts can be assembled in their exact positions within the housing by automated machinery. The contacts can be fed automatically and positioned as a group. The webs hold the contacts in their proper places, so that no significant amount of displacement can occur as a result of shrinkage or as a result of the production tolerances of the plastic parts. Only after the shrinkage has ended and the webs between the contacts in the plug-in area and possibly the additional webs in the connecting area have been removed is the housing assembled into its finished state. The plug shell can be aligned and positioned around the contacts within very narrow tolerances, so that the plug is given the best possible guidance as it is brought together with the mating component to form the plug-in connection.

It is advisable for the plug shell to be attached to the base body by means of latching devices, because this makes it easy to fasten the two parts together. It is also advantageous for the plug shell and/or the base body to have a positioning element for adjusting the position of the plug shell on the base body. Such positioning elements can be provided, for example, on the base body where they surround the contacts laterally in the plug-in area at the point where they emerge from the base body. The plug shell is set down onto these positioning elements and thus precisely positioned. Of course, a corresponding arrangement of positioning elements can also be provided on the plug shell. It has been found advantageous for the base body and the plug shell to be connected permanently to each other, because this means that the contacts will remain permanently in their position relative to the plug shell, which guides them as they are being plugged in.

It is advisable to connect at least two of the contacts of the conductor array in the plug-in area by at least two webs, which are a certain distance apart. The improved positional stability thus achieved leads to optimal positioning results.

In addition to at least one web in the plug-in area, it can be advantageous to provide an additional web between at least two contacts in the connecting area of the conductor array. This web is also removed after the base body has cooled to room temperature.

Which of the variants will be most advantageous depends on the concrete design, such as the length of the areas of the contacts which project out from the plastic.

For the production and use of the hybrid plug housing, it is advantageous for the base body and the plug shell to be connected permanently to each other, preferably by adhesive bonding or welding. It is also advantageous for the webs to be removed only after the hybrid plug housing has been cooled to ambient (room) temperature. As a result, shrinkage-induced positional inaccuracies of the injected contacts of the conductor array are prevented in the most effective possible way.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

FIG. 1 shows a complete hybrid plug housing according to the process of the invention;

FIG. 2 shows a first concrete form of the hybrid plug housing before final assembly;

FIG. 3 shows another view of the hybrid plug housing according to FIG. 2;

FIG. 4 shows a second concrete form of the hybrid plug housing before final assembly; and

FIG. 5 shows a different view of the concrete form according to FIG. 4.

### DETAILED DESCRIPTION OF THE PREFERRED EMBODIMENTS

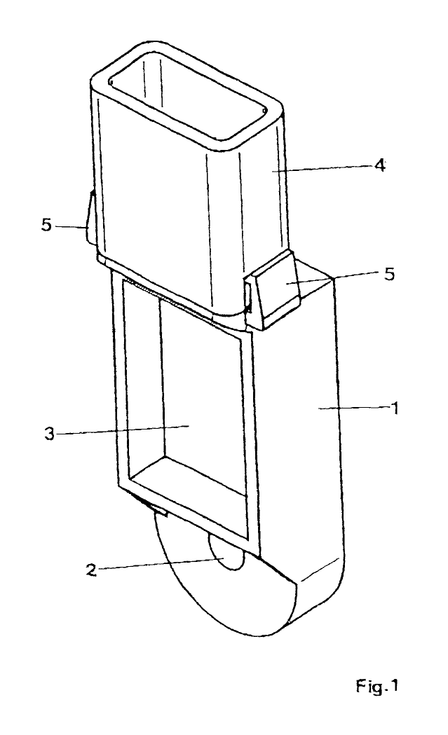

The hybrid plug housing (FIG. 1) has a base body 1 of plastic with a lug 2 for attachment to a structural component. The cavity 3 in the base body 1 can be used to hold an electronic circuit. A plug shell 4 is attached to the base body 1 by means of latching elements 5, 5′. The base body 1 and the plug shell 4 are connected permanently to each other by adhesive bonding or welding.

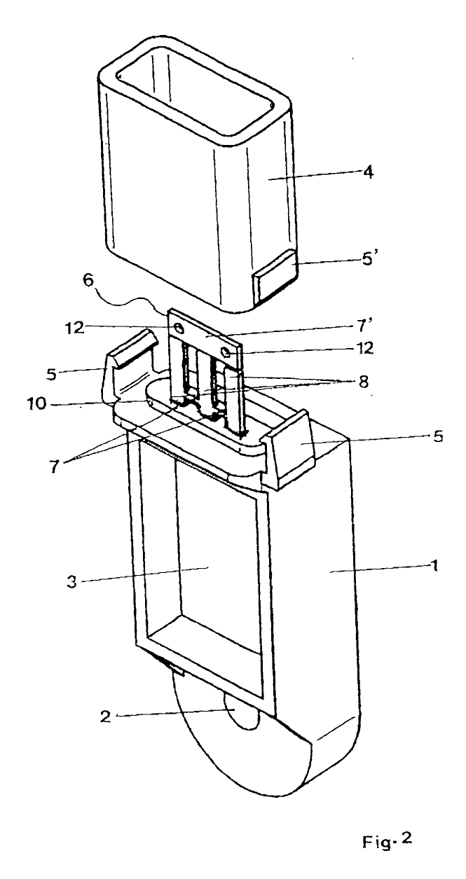

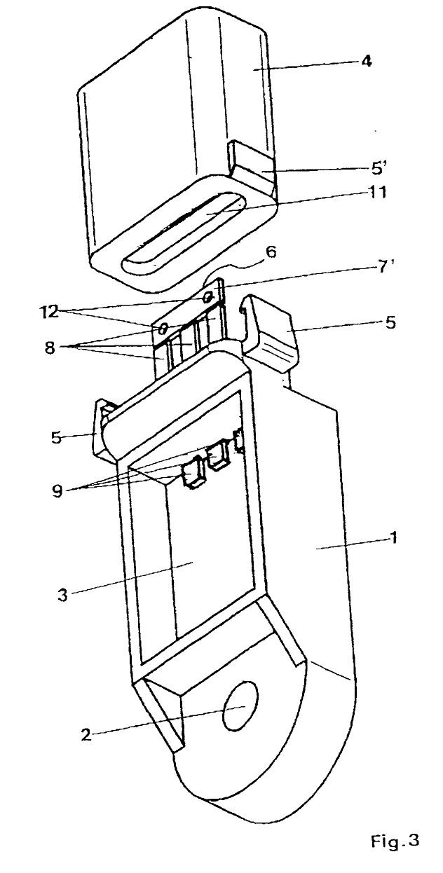

FIGS. 2-4 show several concrete forms in a stage of the process before the hybrid plug housing is completely assembled; that is, the plug shell 4 has still not been attached to the base body 1. As a result, the contacts in the plug-in area 8 of the conductor array 6 are visible. Plastic has been injected around this array so that it is fixed firmly in place in the base body 1. The array is held in the exact position with the help of the holes 12 in the connecting web 7′, and the correct position of the individual contacts in the plug-in area 8 is fixed by the webs 7, 7′ connecting them. FIG. 2 shows the contacts in the plug-in area of the conductor array 6, where the web 7 is located in the area where the plastic has been injected around the conductor array 6, whereas the additional web 7′ connects the contacts in the plug-in area 8 of the conductor array 6 to each other at their free ends. In this embodiment, it is not necessary for webs to connect the contacts in the connecting area 9 (see FIG. 3) to each other.

The base body 1 has a projecting edge 10, which extends around the contacts in the plug-in area 8 of the conductor array 6. This edge 10 serves as a positioning element for adjusting the position of the plug shell 4 on the base body 1. For this purpose, the plug shell 4 has an opening 11 on the side facing the base body 1. The contacts in the plug-in area 8 are inserted through this opening, which rests against the edge 10. The proper position of the shell 4 is thus guaranteed. The plug shell 4 is held on the base body 1 by the latching elements 5, 5′. The two parts are bonded together with an adhesive.

During production, the conductor array 6, consisting of contacts and webs, is fabricated first by, for example, stamping. Thus webs 7, 7′ are provided between the contacts in the plug-in area 8, and possibly additional webs are provided between the contacts in the connecting area 9. These webs remain intact at first. Then the plastic of the base body 1 is injected around the conductor array 6, which thus becomes permanently molded into it. Any possible shrinkage of the plastic of the base body 1 during cooling cannot cause the contacts in the plug-in area 8 to change their position with respect to each other, because they are joined to each other by the webs 7, 7′. After the base body 1 has cooled, the webs 7, 7′ are removed, and the plug shell 4 is attached to the base body 1. With this process, it is possible to achieve the optimum positional adjustment of all the parts with respect to each other, because the conductor array 6 is held securely in position precisely at the point where it is important to guarantee precise relative positioning, namely, at the contacts in the plug-in area 8. After cooling, it is easy to remove the webs 7, 7′ by mechanical or some other suitable means, because there is no difficulty in gaining access to the webs 7, 7′. The plug shell 4, which would make access to the webs difficult if not impossible, is not set in place until after the webs are removed.

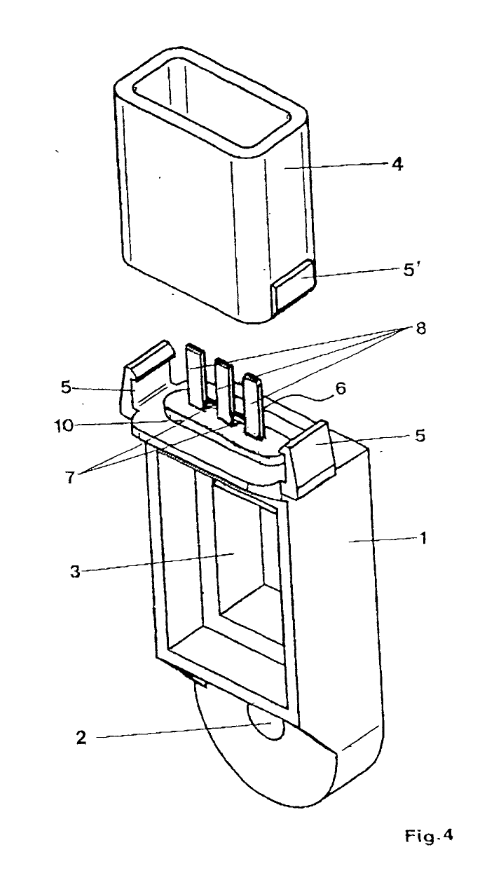

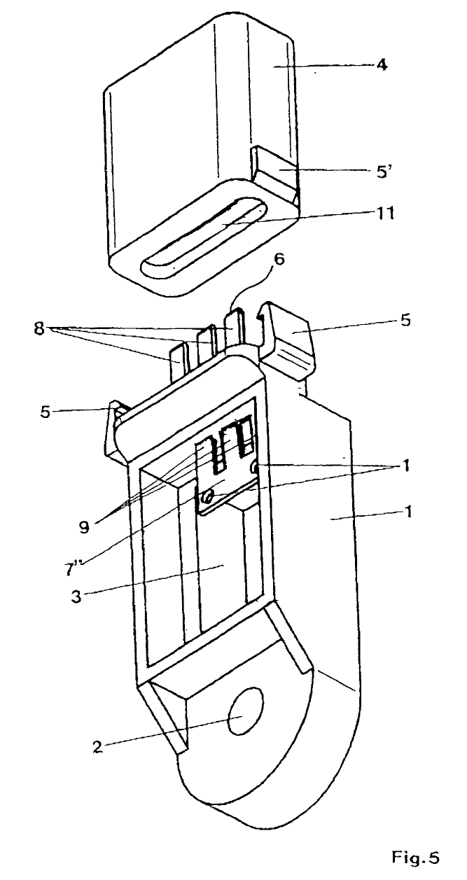

A similar embodiment is shown in FIGS. 4 and 5. Here the webs 7″ are provided on the contacts in the connecting area 9 of the conductor array 6. There is no difficulty in removing these webs 7″ at any point either, after the plastic has cooled, because, in this embodiment, the cavity 3 is designed as a continuous opening, whereas in the form according to FIG. 2, a bottom is provided. Automatic grippers can also be used to insert and hold the conductor array 6 in the injection mold.

Like the base body 1, the plug shell 4 can also be produced by injection-molding. The finished hybrid plug housing is characterized by the precise positioning of both the contacts in the plug area 8 and the plug shell 4, where not only the edge 10 but also various other positioning devices such as knobs or tongue-and-groove connections could also be conceived.

Thus, while there have been shown and described and pointed out fundamental novel features of the present invention as applied to a preferred embodiment thereof, it will be understood that various omissions and substitutions and changes in the form and details of the devices illustrated, and in their operation, may be made by those skilled in the art without departing from the spirit of the present invention. For example, it is expressly intended that all combinations of those elements and/or method steps which perform substantially the same function in substantially the same way to achieve the same results are within the scope of the invention. Substitutions of elements from one described embodiment to another are also fully intended and contemplated. It is also to be understood that the drawings are not necessarily drawn to scale but that they are merely conceptual in nature. It is the intention, therefore, to be limited only as indicated by the scope of the claims appended hereto.”

We claim:

1. A process for producing a hybrid plug housing with a conductor array including at least two contacts, the contacts having a connecting area at one end and a plug-in area at the other end, the process comprising the steps of: connecting together at least two contacts in their plug-in area with at least one web; forming a plastic around the conductor array to form a base body so that the connecting areas and the plug-in areas project out from the base body and remain free of plastic and the web is located outside the base body; removing the web from the plug-in area of the contacts after the base body has cooled to room temperature; and enclosing the plug-in areas of the contacts laterally with a plug shell which is a certain distance away from the contacts by attaching the plug shell to the base body with precise positioning.

2. A process according to claim 1, wherein the forming step includes injecting a plastic around the conductor array.

3. A process according to claim 1, wherein the forming step includes casting a plastic around the conductor array.

4. A process according to claim 1, wherein the connecting step includes connecting the at least two contacts of the conductor array in the plug-in area by at least two webs which are at a distance from one another.

5. A process according to claim 1, further including providing an additional web between at least two contacts in a connecting area of the conductor array, which additional web is in addition to the web in the plug-in area, and further including removing the additional web after the base body cools to room temperature.

6. A process according to claim 1, including connecting the base body and the plug shell permanently together.

7. A process according to claim 6, wherein the step of connecting the base body and the plug shell together includes bonding the base body and the plug shell to each other with an adhesive.

8. A process according to claim 6, wherein the step of connecting the base body and the plug shell together includes welding together the base body and the plug shell.
